(19) United States
(12) Patent Application Publication
(10) Pub. No.: US 2015/0032651 A1
(43) Pub. Date: Jan. 29, 2015

(54) SYSTEM AND METHOD FOR SOCIAL NETWORK ANALYSIS AND INSTRUCTION

(71) Applicants: Craig Tutterow, Chicago, IL (US); Hunter Swartz, Chicago, IL (US); Tyler Swartz, San Francisco, CA (US)

(72) Inventors: Craig Tutterow, Chicago, IL (US); Hunter Swartz, Chicago, IL (US); Tyler Swartz, San Francisco, CA (US)

(21) Appl. No.: 13/952,666

(22) Filed: Jul. 28, 2013

(51) Int. Cl. G06Q 50/20; G06Q 10/00; G06Q 50/00

(52) U.S. Cl. CPC G06Q 50/20; G06Q 50/01; G06Q 10/00
USPC 705/319

(57) ABSTRACT

The present invention generally relates to systems and method for developing and utilizing social networks to achieve a goal. Specifically, this invention relates to systems and methods for the advantageous use of social networks to support an employment search.

### FIELD OF THE INVENTION

The present invention generally relates to systems and method for delivering educational content regarding the development and utilization of social networks to achieve a goal. Specifically, this invention relates to systems and methods for the advantageous use of social networks to support an employment search.

### BACKGROUND

Social networks have come to be a valuable way to connect people. A variety of social networks have been developed that cater to almost any interest and that serve numerous functions, from connecting people socially to connecting them professionally. While these social networks have been successful in connecting people generally, there are a number of ways in which the functionality of these networks could be expanded to be utilized in new ways. One main way to expand the utility of social networks is by using the social connections of a user to help that user achieve a goal.

In particular, current social networks do not offer an analytic functionality that provides a user with a visualization of the strength and interconnectivity of the user's social network. Even more, current social networks and related systems and methods lack the ability to use the analysis of a user's social network to provide the user with instructions and other strategies for developing the user's social network in a way that supports the user in achieving a specific goal. Overall, currently available systems and methods do not allow a user to thoroughly analyze their social network connections and develop a customized strategy to achieve a particular goal, based on social scientific research in the field.

Therefore, there is need in the art for a system and method that analyzes a user's social network connections and provides instruction on how to utilize existing, or build new connections in order to achieve a goal. These and other features and advantages of the present invention will be explained and will become obvious to one skilled in the art through the summary of the invention that follows.

### SUMMARY OF THE INVENTION

Accordingly, it is an aspect of the present invention to provide a system and method for the analysis of a user's social network connections whereby the network analysis is applied to developing a strategy and other support that helps the user achieve a particular goal by utilizing the user's network connections.

According to an embodiment of the present invention, a system for social network analysis and development includes: a social network diagnostic module, comprising computer-executable code stored in non-volatile memory; a networking development module, comprising computer-executable code stored in non-volatile memory; a processor; and a communications means; wherein said social network diagnostic module, said networking development module, said processor, and said communications means are operably connected and are configured to: request social network data of a user, wherein said social network diagnostic module requests access to one or more social networks of said user; receive said social network data of said user, wherein said social network diagnostic module accesses said one or more social networks of said user; analyze said social network data of said user, wherein said social network diagnostic module evaluates said social network data of said user; generate a network visualization map for said user, wherein network diagnostic module creates said network visualization map based on said social network data of said user; transmit said network visualization map to said user; generate a network analysis for said user, wherein network diagnostic module creates said network analysis based on said social network data of said user; request said network analysis of said user, wherein said networking development module requests said network analysis from said social network diagnostic module; receive said network analysis of said user, wherein said networking development module receives said network analysis from said social network diagnostic module; request an objective from said user, wherein said networking development module requests said user to submit a goal said user desires to achieve; receive said objective from said user, wherein said user provides said objective to said networking development module; generate a network development strategy and curriculum, wherein said networking development module bases said network development strategy on said network analysis and said objective of said user; and transmit said network development strategy to said user, wherein said user utilizes said network development strategy to achieve said objective.

According to an embodiment of the present invention, the social network diagnostic module, said networking development module, said processor, and said communications means are further configured to track said user's progress on said network development strategy.

According to an embodiment of the present invention, the social network diagnostic module, said networking development module, said processor, and said communications means are further configured to monitor and provide reminders to said user to keep said user on track with said network development strategy.

According to an embodiment of the present invention, the social network data comprises one or more of social network data factors selected from the group of social network data factors comprising social networks types, user contacts, user social connectivity, user background information, and contact background information.

According to an embodiment of the present invention, the system further includes a contact management module, comprising computer-executable code stored in non-volatile memory, said contact management module operably connected to and configured to work in conjunction with said social network diagnostic module, said networking development module, said processor, and said communications means.

According to an embodiment of the present invention, the contact management module is configured to integrate with said network visualization map to allow said user to view and interact with one or more contacts in said one or more social networks of said user.

According to an embodiment of the present invention, the system includes one or more data stores.

According to an embodiment of the present invention, a method for social network analysis and development includes the steps of: requesting social network data of a user, wherein said social network diagnostic module requests access to one or more social networks of said user; receiving said social network data of said user, wherein said social network diagnostic module accesses said one or more social networks of said user; analyzing said social network data of said user, wherein said social network diagnostic module evaluates said social network data of said user; generating a network visualization map for said user, wherein network diagnostic module creates said network visualization map based on said social network data of said user; transmitting said network visualization map to said user; generating a network analysis for said user, wherein network diagnostic module creates said network analysis based on said social network data of said user; requesting said network analysis of said user, wherein said networking development module requests said network analysis from said social network diagnostic module; receiving said network analysis of said user, wherein said networking development module receives said network analysis from said social network diagnostic module; requesting an objective from said user, wherein said networking development module requests said user to submit a goal said user desires to achieve; receiving said objective from said user, wherein said user provides said objective to said networking development module; generating a network development strategy, wherein said networking development module bases said network development strategy on said network analysis and said objective of said user; and transmitting said network development strategy and curriculum to said user, wherein said user utilizes said network development strategy to achieve said objective.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a schematic of a system, in accordance with an embodiment of the present invention;

FIG. 4 is a process flow of an exemplary method in accordance with an embodiment of the present invention; and

FIG. 5 is a wireframe of a social portal with social network diagram, in accordance with an embodiment of the present invention.

### DETAILED SPECIFICATION

The present invention generally relates to systems and method for delivering educational content regarding the development and utilization of social networks to achieve a goal. Specifically, this invention relates to systems and methods for the advantageous use of social networks to support an employment search.

According to an embodiment of the present invention, a system for social network analysis and development may include a social network diagnostic module, a networking development module, a processor and a communications means. In a preferred embodiment, the social network diagnostic module, networking development module, processor and communications means are operably connected to provide an analysis of a user's social network in addition to guidance on how to develop their network. In an alternate embodiment, the system for social network analysis may further include a contact management module. In further alternate embodiments, the system may include additional or fewer components. One of ordinary skill in the art would appreciate a system for social network analysis and development could be operably configured with a number of different components, and embodiments of the present invention are contemplated for use with any such component.

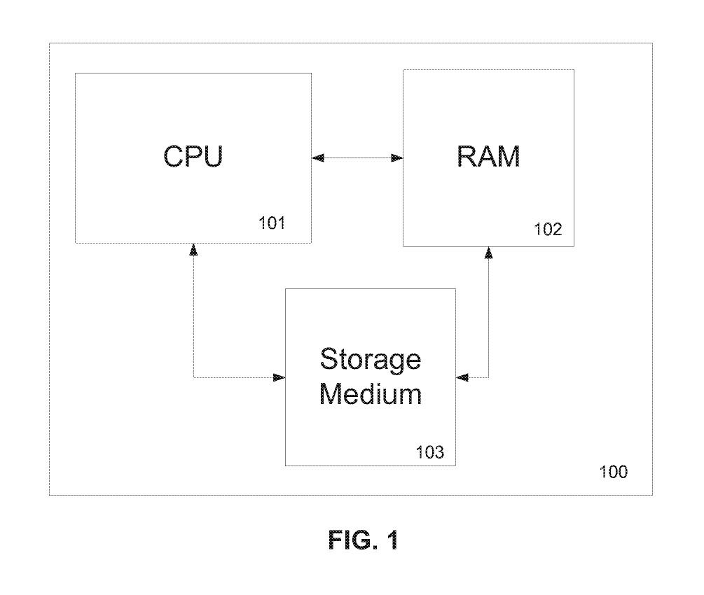

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

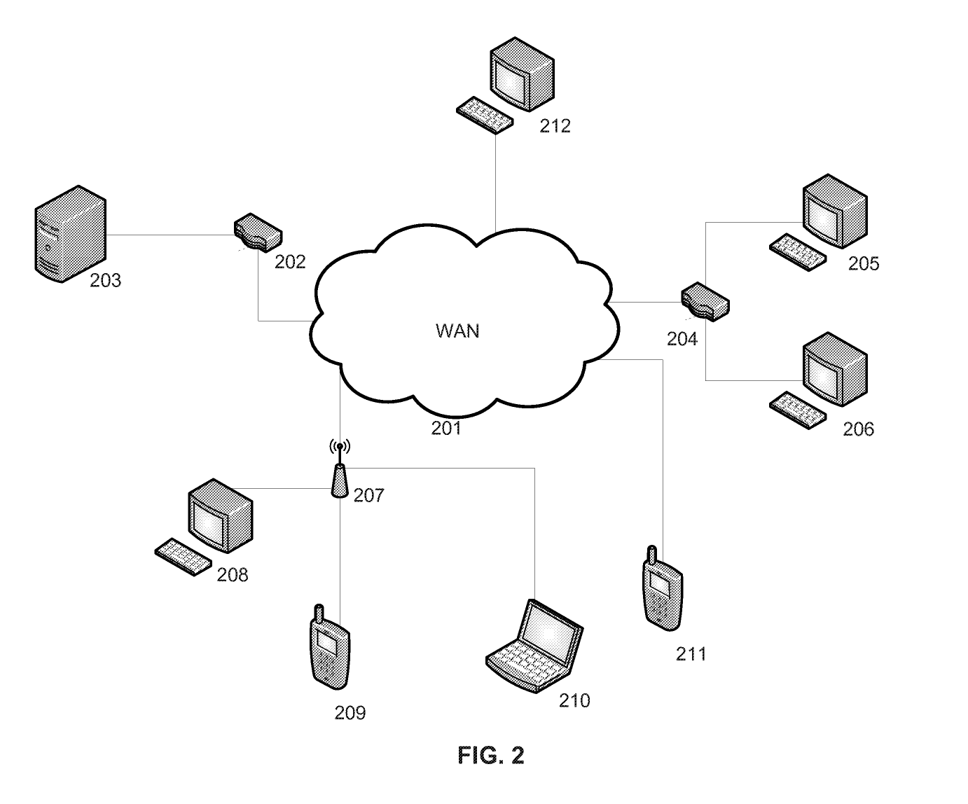

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, a system for social network analysis and development may include a social network diagnostic module. In a preferred embodiment, the social network diagnostic module is primarily responsible for analyzing a user's social network connections. The social network diagnostic module will analyze a user's social network data and compute diagnostic measures on the social structure and contact attributes within that user's social network. One of ordinary skill in the art would appreciate that the social network diagnostic module could be configured to analyze multiple elements of a user's social network data, and embodiments of the present invention are contemplated for use with any such social network data.

According to an embodiment of the present invention, the social network diagnostic module may be configured to analyze a user's social network data. In a preferred embodiment, the user's social network data is comprised of social network data factors including, but not limited to, social networks types, user contacts, user social connectivity, user background information, contact social connectivity, and contact background information. In alternate embodiments, the social network data may be comprised of additional or fewer types of social network data factors. One of ordinary skill in the art would appreciate social network data could be comprised of a variety of different social network data factors, and embodiments of the present invention are contemplated for use with any such social network data factors.

According to an embodiment of the present invention, the social network data is comprised of social network types, which are the types of social networks a user belongs to. In a preferred embodiment, the types of social networks a user belongs to include, but are not limited to, professional social networks, interest-based social networks, and standard social networks. In the preferred embodiment, professional social networks are comprised of contacts that are associated with a user's profession or career, interest-based social networks are comprised of contacts that share similar interests with the user, and standard social networks are comprised of friends, relatives, and other acquaintances of the user. One of ordinary skill in the art would appreciate that social network data could be comprised on any social network type, and embodiments of the present invention are contemplated to be used with any type of social network.

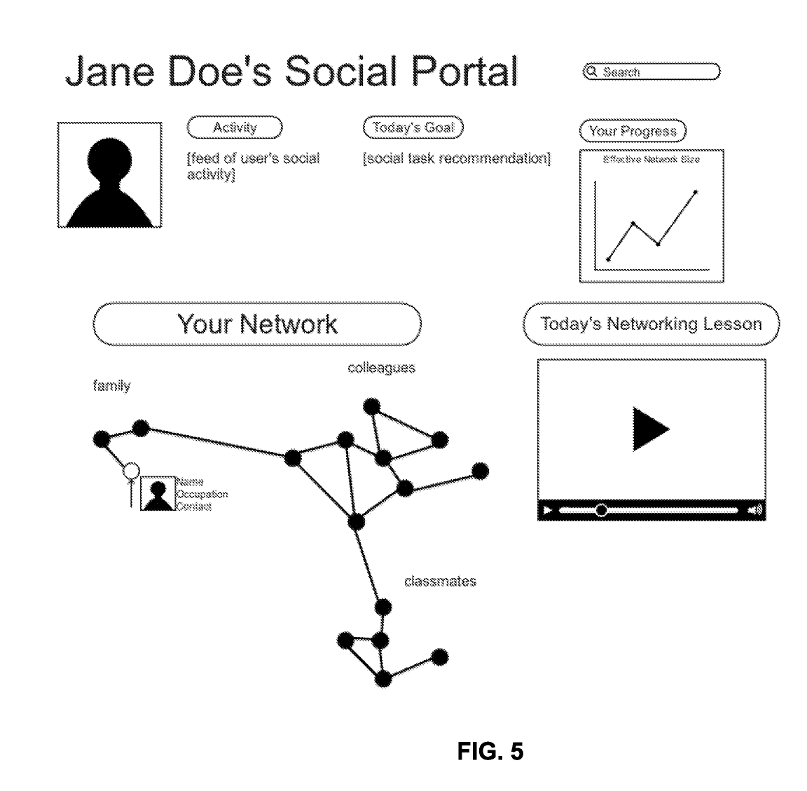

According to an embodiment of the present invention, the social network data is comprised of user contacts, and the connectivity of those contacts. As shown in FIG. 5, which is a wireframe of an exemplary embodiment of connectivity, this is referred to as an egocentric social network, and includes both first and second degree connections. In a preferred embodiment, the user's contacts are all of the people that are in one or more of the user's social networks.

According to an embodiment of the present invention, the social network data is comprised of user social connectivity, which is the user's social connectivity. In a preferred embodiment, the user's social connectivity is the way in which the user's social networks relate to the user's contacts' social networks. Additionally, the user's social connectivity is useful for determining how a user is connected, if at all, to a person that is not among the direct contacts of the user's social network.

According to an embodiment of the present invention, the social network data is comprised of user background information, which is the user's background information. In a preferred embodiment, the user's background information is comprised of, but not limited to, demographic information (such as age, sex, location, education, etc.), career information (such as place of employment, position, etc.), and interests. One of ordinary skill in the art would appreciate a user's background information could be comprised of a variety of facts and figures, and embodiments of the present invention are contemplated for use with any such facts and figures.

According to an embodiment of the present invention, the social network data is comprised of contact background information, which is the user's contacts' background information. In a preferred embodiment, the user's contacts' background information is comprised of, but not limited to, demographic information (such as age, sex, location, education, etc.), career information (such as place of employment, position, etc.), and interests. One of ordinary skill in the art would appreciate a user's contacts' background information could be comprised of a variety of facts and figures, and embodiments of the present invention are contemplated for use with any such facts and figures.

According to an embodiment of the present invention, the social network diagnostic module may be configured to provide a network visualization map to a user. In a preferred embodiment, the network visualization map is a graphic representation or schematic of a user's social network connectivity. The network visualization map may show how a user is connected to the various contacts in the user's network, as well as how the user is connected to contacts of the user's contacts. In this way, the user is provided a visual representation of how the user is connected to people beyond the user's direct social network. One of ordinary skill in the art would appreciate there are numerous applications for a network visualization map, and embodiments of the present invention are contemplated for use with any such application.

According to an embodiment of the present invention, the social network diagnostic module may be configured to provide a network analysis to a user. In a preferred embodiment, the network analysis is an evaluation of the strengths, weaknesses, and make-up of a user's social networks and related contacts, based at least in part on network analytic measures developed in the social scientific literature. In particular, the network analysis can reveal information about the health of the user's social network and how the user's activities affect the health of the user's social network. The network analysis may also reveal information that can be used to create a network development strategy, whereby the user is provided with techniques and guidance to improve the health of their social network, such as via interactions with their current contacts, or in the formation of new contacts. One of ordinary skill in the art would appreciate that the information revealed by a network analysis could be used for a variety of purposes, and embodiments of the present invention are contemplated for use with such purpose.

According to an embodiment of the present invention, a system for social network analysis and development may include a networking development module. In a preferred embodiment, the networking development module is configured to create a network development strategy. In the preferred embodiment, the network development strategy is derived from the network analysis. The network development strategy is generally guidance that is intended to assist a user improve the weaknesses in their social network that were identified by the network analysis. In the preferred embodiment, the guidance provided by the network development strategy may include, but is not limited to, educational lessons on how to utilize a social network, instructions for developing stronger contacts, how to utilize existing contacts to make new contacts, as well as other tips, diagrams, and pedagogical videos to illustrate various networking concepts. One of ordinary skill in the art would appreciate that a network development strategy could utilize a variety of techniques and tools to help a user develop their social network, and embodiments of the present invention are contemplated for use with any such technique or tool.

According to an embodiment of the present invention, the network development strategy may be utilized to by a user to achieve a particular goal or objective. In a preferred embodiment, the networking development module will request a user to submit an objective that the user desires to accomplish. In the preferred embodiment, the networking development module will incorporate the user's objective into the network development strategy so that user may more easily achieve the objective. In particular, the networking development module will create a network development strategy that provides specific guidance and instruction that is devised specifically to help the user archive their particular objective. As an illustrative example, the network development strategy may advise the user to focus on developing the aspects of their social network that would help the user most easily achieve their objective, i.e. by developing the professional and career aspects of their social networks when the user is looking for a job. Overall, the networking development module will create a network development strategy that guides a user to improve the health of their social network in a manner that helps the user achieve their objective.

According to an embodiment of the present invention, the networking development module may be configured to monitor a user's progress within the network development strategy. In the preferred embodiment, the networking development module will monitor whether and to what extent the user is following the guidance and instruction provided by the network development strategy. Further, in the preferred embodiment the networking development module will provide reminders to the user as to what steps the user should take to strengthen their social network.

According to an embodiment of the present invention, the social network diagnostic module may be configured to provide feedback as to how well a user's network development strategy is working. In a preferred embodiment, the social network diagnostic module will monitor the changes that occur with a user's social network as the user's improves their network according to the network development strategy. In the preferred embodiment, the social network diagnostic module may be further configured to communicate with the networking development to provide feedback so that the networking development module can modify and increase the effectiveness of the network development strategy.

According to an embodiment of the present invention, a system for social network analysis and development may include a contact management module. In a preferred embodiment, the contact management module is configured to use the information from and integrate with the network visualization map. By integrating with the network visualization map, the contact management module allows a user to intuitively view and interact with their network based on how the user's contacts are connected to each other in the user's social network. One of ordinary skill in the art would appreciate there are numerous functions that could be served by a contact management module, and embodiments of the present invention are contemplated for use with any such function.

For the purpose of illustrating advantageous use cases, the following examples are provided. As a reference point, users are generally not aware of the advantages and disadvantages of different types of network structures. Research on social networks has demonstrated that those who occupy ‘closed,’ or dense networks, where a large proportion of contacts are connected to each other, tend to perform less well in their careers. The basic intuition behind this result is that they are less exposed to diverse information, and are risk averse due to their dependence on a single, cohesive group for social support. On the contrary, individuals that have a network rich in ‘structural holes,’ have access to diverse pools of information, and are more likely to take risks as they have multiple sources of social support. In some situations, an open network is more desirable (e.g. search tasks, innovation tasks). For others, like building or maintaining a reputation, it is actually preferable to have a more closed network, where one's contacts communicate with each other.

In the above described use case, the system will, through network diagnostic, take data from a user's online social network and compute measures from the network literature, such as, but not limited to: network constraint, network density, network hierarchy, effective network size, the eigenvector centrality of contacts, and other relevant metrics. The system will also use community detection algorithms to identify cohesive groups in a user's network for more intuitive displays of the network data. The results will be interpreted and reported to the user in easy to understand representation (see, FIG. 5).

According to the above analysis and the user's goal, the system will lay out a customized curriculum for cultivating their network to achieve the established professional goal, as well as graphical and communication tools to make that happen within the platform. The system is configured to tracks the user's progress towards the optimal network structure for the given goal. In a search task, it may track an increase in effective size, or a decrease in network constraint. For reputation building, it might track contact density in a target clique. These factors will be based on knowledge about effective context and user-specific strategies. Again, FIG. 5 provides a preliminary wireframe overview of a UI of the system, in accordance with an embodiment of the present invention.

### Exemplary Embodiment

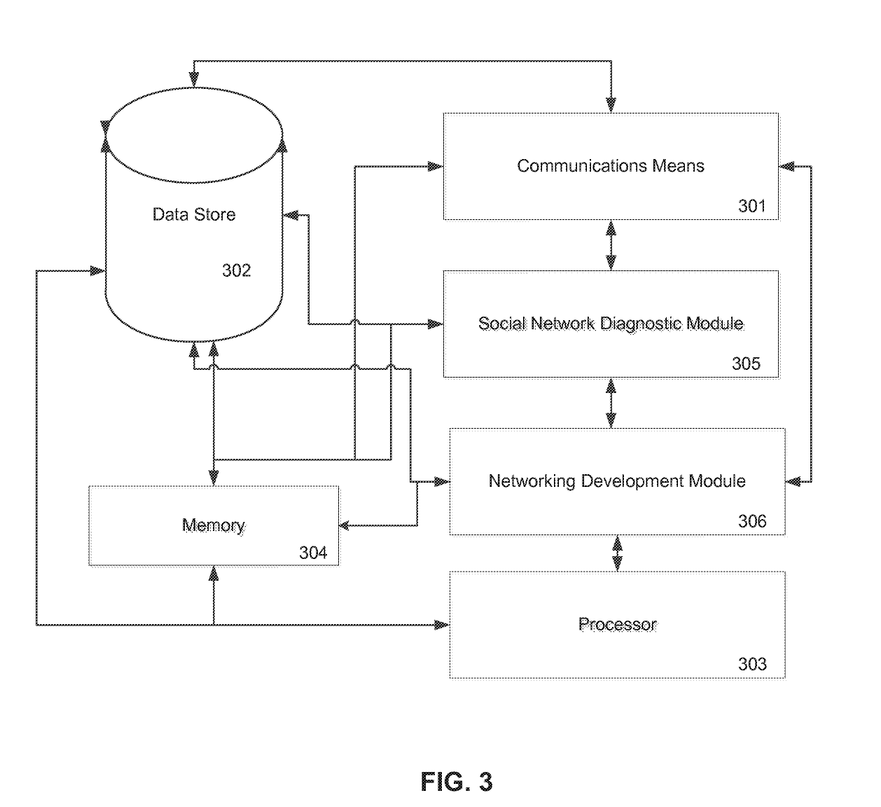

Turning now to FIG. 3, according to an embodiment of the present invention, a system for social network analysis and development is comprised of one or more communications means 301, one or more data stores 302, a processor 303, memory 304, a social network diagnostic module 305, and a networking development module 306. In alternate embodiments, the system may have additional or fewer components. One of ordinary skill in the art would appreciate that the system may be operable with a number of optional components, and embodiments of the present invention are contemplated for use with any such optional component.

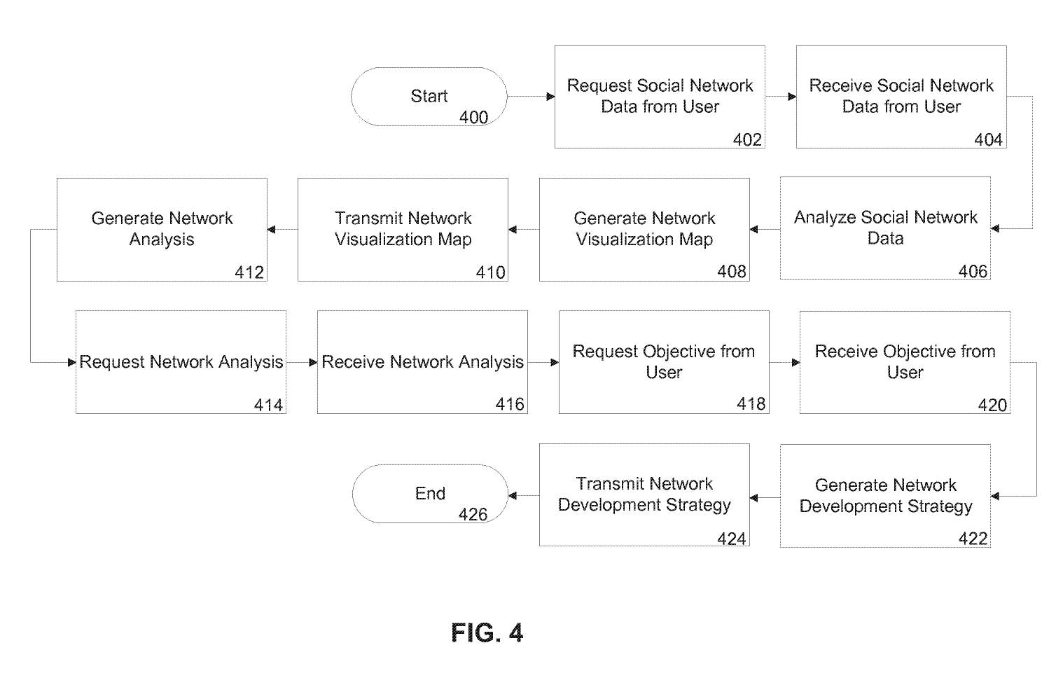

Turning now to FIG. 4, an exemplary method in accordance with an embodiment of the present invention is shown. In this method, the process starts at step 400 with a user engaging the system.

At step 402, the system requests the user for social network data. The user grants the system permission to access their social network data.

At step 404, the system receives the social network data having been granted access to by the user.

At step 406, the system, in particular the social network diagnostic module, analyzes the the user's social network data. This analysis will include an evaluation of the user's contacts and connections, as well as other attributes of the user's social network(s) that will provide a diagnostic of the health and scope of the user's social network(s).

At step 408, the social network diagnostic module generates a network visualization map based upon the analysis of the user's social network data. The network visualization map is then transmitted to the user (step 410) and provides a graphic representation of the social network data that was analyzed so that the user can more easily learn about the connectivity provided by their social network.

At step 412, the social network diagnostic module generates a network analysis. The network analysis is a thorough evaluation of the user's social network types, connectivity, background information, the user's contacts, and the background information of the user's contacts. This information is computed to provide a comprehensive picture of the health of the user's social network(s), as well as the unrealized connections and resources that are available to the user.

At step 414, the networking development module requests the network analysis from the social network diagnostic module. The networking development module receives the network analysis from the social network diagnostic module (step 416) and will use that information to generate a network development strategy.

At step 418, the networking development module requests the user to provide an objective. The objective is a goal that the user desires to achieve. The networking development module receives the objective from the user (step 420). The user's objective is required so that the networking development module can develop a customized network development strategy for the user.

At step 422, the networking development module generates a network development strategy. The network development strategy is a course of action that the will help the user achieve their objective. Specifically, the network development strategy provides customized guidance to the user on how to develop and utilize the strength of their social network(s) to more efficiently achieve their objective. This network development strategy is provided to the user (step 424), where the user can receives instruction on how to user their network to achieve their objective, as well as other support that teach the user to maintain a strong social network that can be relied on to achieve future objectives.

At step 426, the process ends with the user receiving the network development strategy and starting the recommended course of action that will help the achieve their objective.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, node.js, Python, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for social network analysis and development, the system comprising:
a social network diagnostic module, comprising computer-executable code stored in non-volatile memory;
a networking development module, comprising computer-executable code stored in non-volatile memory;
a processor; and
a communications means;
wherein said social network diagnostic module, said networking development module, said processor, and said communications means are operably connected and are configured to:
request social network data of a user, wherein said social network diagnostic module requests access to one or more social networks of said user;
receive said social network data of said user, wherein said social network diagnostic module accesses said one or more social networks of said user;
analyze said social network data of said user, wherein said social network diagnostic module evaluates said social network data of said user;
generate a network visualization map for said user, wherein network diagnostic module creates said network visualization map based on said social network data of said user;
transmit said network visualization map to said user;
generate a network analysis for said user, wherein network diagnostic module creates said network analysis based on said social network data of said user;
request said network analysis of said user, wherein said networking development module requests said network analysis from said social network diagnostic module;
receive said network analysis of said user, wherein said networking development module receives said network analysis from said social network diagnostic module;
request an objective from said user, wherein said networking development module requests said user to submit a goal said user desires to achieve;
receive said objective from said user, wherein said user provides said objective to said networking development module;
generate a network development strategy, wherein said networking development module bases said network development strategy on said network analysis and said objective of said user; and
transmit said network development strategy to said user, wherein said user utilizes said network development strategy to achieve said objective.

2. The system of claim 1, wherein said social network diagnostic module, said networking development module, said processor, and said communications means are further configured to track said user's progress on said network development strategy.

3. The system of claim The system of claim 1, wherein said social network diagnostic module, said networking development module, said processor, and said communications means are further configured to track said user's progress on said network development strategy., wherein said social network diagnostic module, said networking development module, said processor, and said communications means are further configured to provide a reminder to said user to keep said user on track with said network development strategy.

4. The system of claim 1, wherein said social network data comprises one or more of social network data factors selected from the group of social network data factors comprising social networks types, user contacts, user social connectivity, user background information, and contact background information.

5. The system of claim 1, further comprising a contact management module, comprising computer-executable code stored in non-volatile memory, said contact management module operably connected to and configured to work in conjunction with said social network diagnostic module, said networking development module, said processor, and said communications means.

6. The system of claim The system of claim 1, further comprising a contact management module, comprising computer-executable code stored in non-volatile memory, said contact management module operably connected to and configured to work in conjunction with said social network diagnostic module, said networking development module, said processor, and said communications means., wherein said contact management module is configured to integrate with said network visualization map to allow said user to view and interact with one or more contacts in said one or more social networks of said user.

7. The system of claim 1, further including one or more data stores.

8. A method for social network analysis and development, the method comprising the steps of:
requesting social network data of a user, wherein said social network diagnostic module requests access to one or more social networks of said user;
receiving said social network data of said user, wherein said social network diagnostic module accesses said one or more social networks of said user;
analyzing said social network data of said user, wherein said social network diagnostic module evaluates said social network data of said user;
generating a network visualization map for said user, wherein network diagnostic module creates said network visualization map based on said social network data of said user;
transmitting said network visualization map to said user;
generating a network analysis for said user, wherein network diagnostic module creates said network analysis based on said social network data of said user;
requesting said network analysis of said user, wherein said networking development module requests said network analysis from said social network diagnostic module;
receiving said network analysis of said user, wherein said networking development module receives said network analysis from said social network diagnostic module;
requesting an objective from said user, wherein said networking development module requests said user to submit a goal said user desires to achieve;
receiving said objective from said user, wherein said user provides said objective to said networking development module;
generating a network development strategy, wherein said networking development module bases said network development strategy on said network analysis and said objective of said user; and
transmitting said network development strategy to said user, wherein said user utilizes said network development strategy to achieve said objective.

9. The method of claim A method for social network analysis and development, the method comprising the steps of:, further comprising the step of tracking said user's progress on said network development strategy.

10. The method of claim The method of claim A method for social network analysis and development, the method comprising the steps of:, further comprising the step of tracking said user's progress on said network development strategy., further comprising the step of providing a reminder to said user to keep said user on track with said network development strategy.

11. The method of claim A method for social network analysis and development, the method comprising the steps of:, wherein said social network data comprises one or more of social network data factors selected from the group of social network data factors comprising social networks types, user contacts, user social connectivity, user background information, and contact background information.
